(19) United States
(12) Patent Application Publication
(10) Pub. No.: US 2026/0184194 A1
(43) Pub. Date: Jul. 2, 2026

(54) BATTERY ELECTRIC VEHICLE AND STORAGE MEDIUM

(71) Applicant: TOYOTA JIDOSHA KABUSHIKI KAISHA, Toyota-shi (JP)

(72) Inventors: Kentaroh KANZAKI, Sunto-gun (JP); Ryohei YUASA, Okazaki-shi (JP); Yusuke FURUHASHI, Nagoya-shi (JP)

(73) Assignee: TOYOTA JIDOSHA KABUSHIKI KAISHA, Toyota-shi (JP)

(21) Appl. No.: 19/321,733

(22) Filed: Sep. 8, 2025

(30) Foreign Application Priority Data
Dec. 27, 2024 (JP) 2024-231982

(51) Int. Cl. B60L 15/20; B60L 50/60

(52) U.S. Cl. CPC B60L 15/2054; B60L 50/60; B60L 2210/42; B60L 2240/50; B60L 2250/24; B60L 2250/28

(57) ABSTRACT

A battery electric vehicle includes a shifter, and a control device. The control device is configured to execute multiple types of automatic driving force controls of changing the driving force. The manual driving force control includes a first mode in which the input from the driver includes an operation of the shifter and an output characteristic of the electric motor is switchable in multiple stages by the operation of the shifter, and a second mode in which the input from the driver does not include the operation of the shifter. The types of automatic driving force controls include a first-type automatic driving force control that operates during driving in the first mode and also operates during driving in the second mode, and a second-type automatic driving force control that does not operate during driving in the first mode and operates during driving in the second mode.

### CROSS-REFERENCE TO RELATED APPLICATION

This application claims priority to Japanese Patent Application No. 2024-231982 filed on December 27, 2024. The disclosure of the above-identified application, including the specification, drawings, and claims, is incorporated by reference herein in its entirety.

### BACKGROUND

### 1. Technical Field

The present disclosure relates to a battery electric vehicle that travels with a driving force generated by a motor, and specifically, to a battery electric vehicle including a shifter operable by a driver. In addition, the present disclosure relates to a storage medium for a battery electric vehicle including a shifter operable by a driver.

### 2. Description of Related Art

Japanese Unexamined Patent Application Publication No. 2024-73134 (JP 2024-73134 A) discloses a technique in which a battery electric vehicle includes a shifter and an output characteristic of an electric motor is changed in multiple stages in response to an operation of the shifter. According to the technique, a driver can enjoy a driving feel similar to that of an engine vehicle with a manual transmission (hereinafter, an MT vehicle) in the battery electric vehicle.

### SUMMARY

As a function of assisting driving performed by a driver, multiple types of automatic driving force control that change a driving force regardless of input from the driver are implemented in a battery electric vehicle. However, in a case where unintended driving force control is executed, a driver who wants to enjoy driving via an operation of a shifter may perceive a decrease in drivability.

The present disclosure has been made in view of the above-described issues. One object of the present disclosure is to improve drivability in a case where a driver drives a battery electric vehicle by operating a shifter.

The present disclosure provides a battery electric vehicle for achieving the above-described object. A battery electric vehicle according to one embodiment of the present disclosure is a battery electric vehicle that travels with a driving force generated by an electric motor, and includes a shifter operable by a driver and a control device.

The control device is configured to be able to execute multiple types of automatic driving force control of changing the driving force regardless of input from the driver during execution of manual driving force control of changing the driving force in response to the input from the driver.

The manual driving force control includes a first mode in which the input from the driver includes an operation of the shifter, and an output characteristic of the electric motor is switchable in multiple stages by the operation of the shifter, and a second mode in which the input from the driver does not include the operation of the shifter.

In addition, the multiple types of automatic driving force control include first-type automatic driving force control that is operated during driving in the first mode and is also operated during driving in the second mode, and second-type automatic driving force control that is not operated during the driving in the first mode and is operated during the driving in the second mode.

In addition, the present disclosure provides a storage medium storing a program for achieving the above-described object. A storage medium according to one embodiment of the present disclosure is a storage medium storing a program for a battery electric vehicle including a shifter operable by a driver, and the program is configured to cause an in-vehicle computer to execute multiple types of automatic driving force control of changing a driving force regardless of input from the driver during execution of manual driving force control of changing the driving force in response to the input from the driver.

Here, the manual driving force control includes a first mode in which the input from the driver includes an operation of the shifter, and an output characteristic of an electric motor is switchable in multiple stages by the operation of the shifter, and a second mode in which the input from the driver does not include the operation of the shifter.

In addition, the multiple types of automatic driving force control include first-type automatic driving force control that is operated during driving in the first mode and is also operated during driving in the second mode, and second-type automatic driving force control that is not operated during the driving in the first mode and is operated during the driving in the second mode.

According to the present disclosure, it is possible to switch between the operation and non-operation of the multiple types of automatic driving force control in accordance with the mode of the manual driving force control. As a result, it is possible to improve drivability in a case where the driver drives the battery electric vehicle by operating the shifter.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a power control system of a battery electric vehicle according to the present embodiment;

FIG. 2 is a graph showing an example of each of an engine model, a clutch model, and a transmission model that configure a vehicle model;

FIG. 3 is a flowchart showing a first example of determination of the operation and non-operation of an automatic driving force control;

FIG. 4 is a flowchart showing a second example of the determination of the operation and non-operation of the automatic driving force control; and

FIG. 5 is a block diagram showing a modification of the configuration of the power control system of the battery electric vehicle.

### DETAILED DESCRIPTION OF EMBODIMENTS

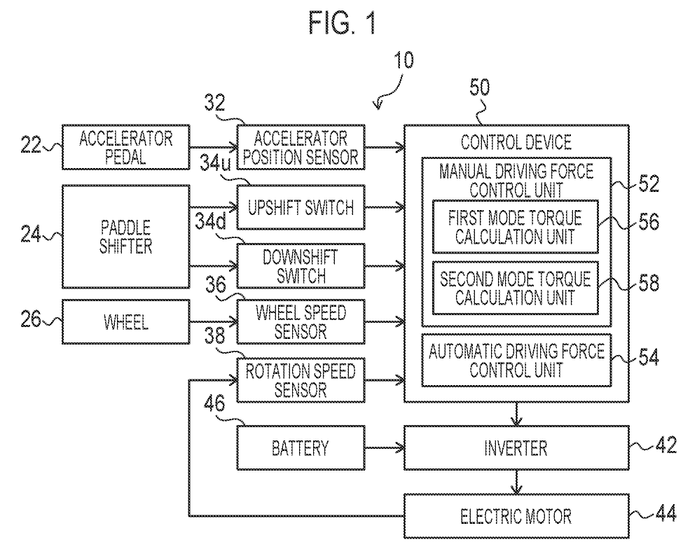

FIG. 1 is a block diagram showing a configuration of a power control system of a battery electric vehicle 10 according to the present embodiment. The battery electric vehicle 10 includes an electric motor 44, a battery 46, and an inverter 42. The electric motor 44 is a power device for traveling. The battery 46 stores electric energy for driving the electric motor 44. That is, the battery electric vehicle 10 is a battery electric vehicle (BEV) that travels with the electric energy stored in the battery 46. The inverter 42 converts a direct current electric power input from the battery 46 during acceleration into a drive electric power of the electric motor 2. In addition, the inverter 42 converts a regenerative electric power input from the electric motor 44 during deceleration into a direct current electric power that is used to charge the battery 46.

The battery electric vehicle 10 includes an accelerator pedal 22 for the driver to input an acceleration request for the battery electric vehicle 10. An accelerator position sensor 32 for detecting an accelerator operation amount is provided in the accelerator pedal 22.

The battery electric vehicle 10 includes a paddle shifter 24. The paddle shifter 24 is attached to a steering wheel or a steering column. The paddle shifter 24 includes an upshift switch 34u and a downshift switch 34d that decide an operation position. The upshift switch 34u generates an upshift signal by being pulled forward, and the downshift switch 36d generates a downshift signal by being pulled forward.

A wheel speed sensor 36 is provided in a wheel 26 of the battery electric vehicle 10. The wheel speed sensor 36 is used as a vehicle speed sensor for detecting a vehicle speed of the battery electric vehicle 10. In addition, the electric motor 44 is provided with a rotation speed sensor 38 for detecting a rotation speed of the electric motor 44.

The battery electric vehicle 10 includes a control device 50. The control device 50 controls the electric motor 44 through PWM control of the inverter 42. Various sensor signals including signals from the accelerator position sensor 32, the upshift switch 34u, the downshift switch 34d, the wheel speed sensor 36, and the rotation speed sensor 38 are input to the control device 50. The control device 50 processes these signals and calculates a motor torque command value for PWM control of the inverter 42.

The control device 50 is an in-vehicle computer mounted on the battery electric vehicle 10 and more specifically, is an ECU. The control device 50 may be a combination of a plurality of ECUs. The control device 50 includes a manual driving force control unit 52 and an automatic driving force control unit 54. The manual driving force control unit 52 includes a first mode torque calculation unit 56 and a second mode torque calculation unit 58. Each of the units 52, 54, 56, 58 may be a function of an ECU obtained by executing a program recorded in a memory by a processor, or an independent ECU may be associated with each of the units 52, 54, 56, 58. The memory is an example of a storage medium.

The manual driving force control unit 52 is a unit that executes a manual driving force control of changing a driving force in response to an input from the driver. The input from the driver in the manual driving force control includes at least the operation of the accelerator pedal 22. The manual driving force control includes a first mode and a second mode as control modes of the electric motor 44 in which the operation of the accelerator pedal 22 is used as an input. The manual driving force control unit 52 switches the control mode between the first mode and the second mode in response to an operation of a mode selector switch (not shown).

The first mode is a control mode for driving the battery electric vehicle 10 like an MT vehicle. The first mode is programmed such that an output characteristic of the electric motor 44 with respect to the operation of the accelerator pedal 22 is changed in accordance with an upshift operation and a downshift operation with respect to the paddle shifter 24. Calculation of a motor torque during execution of the first mode is performed by the first mode torque calculation unit 56.

The first mode torque calculation unit 56 includes a vehicle model described below. The vehicle model is a model for calculating a drive wheel torque that is to be obtained by the operations of the accelerator pedal 22 and the paddle shifter 24 in a case where it is assumed that the battery electric vehicle 10 is an MT vehicle. The first mode torque calculation unit 56 converts the drive wheel torque calculated by the vehicle model into a motor torque using a reduction ratio from an output shaft of the electric motor 44 to the drive wheel.

The second mode is a normal control mode for driving the battery electric vehicle 10 as a general BEV. The second mode is programmed to continuously change the output of the electric motor 44 in response to an operation of the accelerator pedal 22. The second mode is programmed such that the upshift operation and the downshift operation are not received. Calculation of the motor torque during execution of the second mode is performed by the second mode torque calculation unit 58.

The second mode torque calculation unit 58 has a function of calculating a motor torque in a case where the electric motor 44 is controlled in the second mode. The second mode torque calculation unit 58 stores a motor torque command map. The motor torque command map is a map for deciding a motor torque from the accelerator operation amount and the rotation speed of the electric motor 44. The signal of the accelerator position sensor 32 and the signal of the rotation speed sensor 38 are input to each parameter of the motor torque command map. A motor torque corresponding to these signals is output from the motor torque command map. Therefore, in the second mode, even in a case where the driver operates the paddle shifter 24, the operation is not reflected in the motor torque.

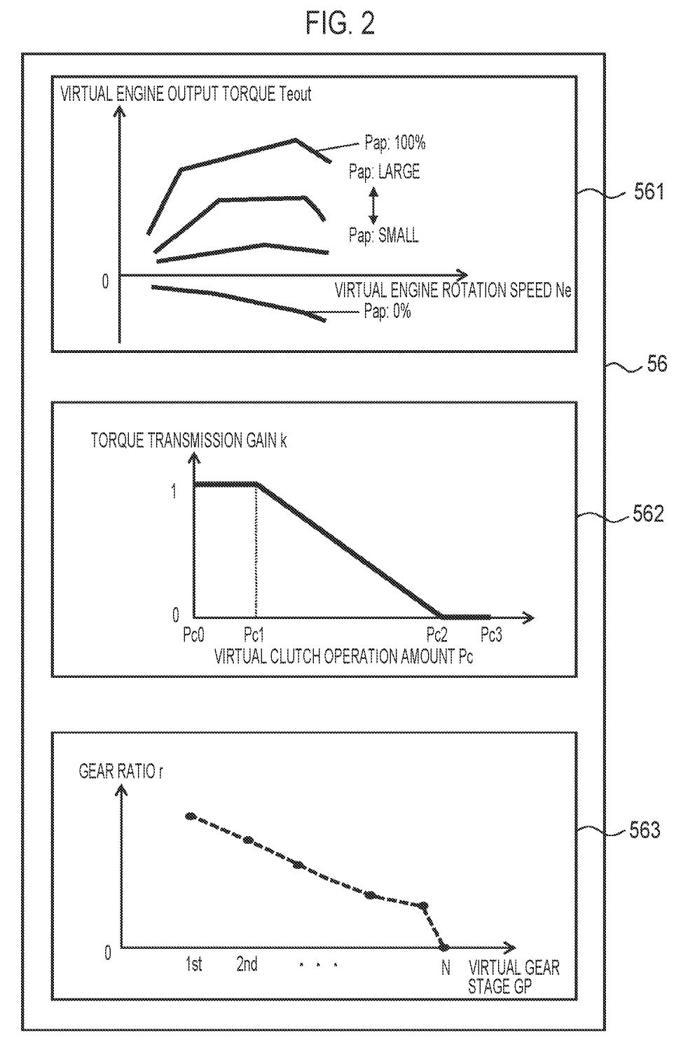

The vehicle model included in the first mode torque calculation unit 56 will be described with reference to FIG. 2. As shown in FIG. 2, the vehicle model includes an engine model 561, a clutch model 562, and a transmission model 563. The engine, the clutch, and the transmission that are virtually implemented by the vehicle model are referred to as a virtual engine, a virtual clutch, and a virtual transmission, respectively. In the engine model 561, the virtual engine is modeled. In the clutch model 562, the virtual clutch is modeled. In the transmission model 563, the virtual transmission is modeled.

The engine model 561 calculates a virtual engine rotation speed and a virtual engine output torque. The virtual engine rotation speed is calculated from a wheel speed, an overall reduction ratio, and a slip rate of the virtual clutch. The virtual engine output torque is calculated from the virtual engine rotation speed and the accelerator operation amount. As shown in FIG. 2, a map in which a relationship between the accelerator operation amount Pap, the virtual engine rotation speed Ne, and the virtual engine output torque Teout is defined is used for calculating the virtual engine output torque. In this map, the virtual engine output torque Teout with respect to the virtual engine rotation speed Ne is given for each accelerator operation amount Pap. The torque characteristic shown in FIG. 2 can be set to a characteristic assumed for a gasoline engine or can be set to a characteristic assumed for a diesel engine. In addition, the torque characteristic can be set to a characteristic assumed for a naturally aspirated engine or can be set to a characteristic assumed for a supercharge engine.

The clutch model 562 calculates a torque transmission gain. The torque transmission gain is a gain for calculating a degree of torque transmission of the virtual clutch corresponding to the virtual clutch operation amount. The virtual clutch operation amount is normally 0%, and is temporarily increased to 100% in conjunction with switching of a virtual gear stage of the virtual transmission. The clutch model 562 has a map as shown in FIG. 2. In the map, the torque transmission gain k is given with respect to the virtual clutch operation amount Pc. In FIG. 2, Pc0 corresponds to a position where the virtual clutch operation amount Pc is 0%, and Pc3 corresponds to a position where the virtual clutch operation amount Pc is 100%. A range from Pc0 to Pc1 and a range from Pc2 to Pc3 are dead zones in which the torque transmission gain k does not change regardless of the virtual clutch operation amount Pc. The clutch model 562 calculates a clutch output torque using the torque transmission gain. The clutch output torque is a torque output from the virtual clutch. In addition, the clutch model 562 calculates the slip rate. The slip rate is used for calculating the virtual engine rotation speed in the engine model 561. For the calculation of the slip rate, a map in which the slip rate is given with respect to the virtual clutch operation amount, similarly to the torque transmission gain, can be used.

The transmission model 563 calculates a gear ratio (transmission ratio). The gear ratio is a gear ratio decided by a virtual gear stage in the virtual transmission. The virtual gear stage is up-shifted by one stage in response to the upshift operation of the paddle shifter 24, and the virtual gear stage is down-shifted by one stage in response to the downshift operation of the paddle shifter 24. The transmission model 563 has a map as shown in FIG. 2. In the map, the gear ratio r is given to the virtual gear stage GP such that the gear ratio r decreases as the virtual gear stage GP increases. The transmission model 563 calculates a transmission output torque using the gear ratio and the clutch output torque obtained from the map. The transmission output torque discontinuously changes in accordance with the switching of the gear ratio.

The vehicle model calculates a drive wheel torque using a predetermined reduction ratio. The reduction ratio is a fixed value decided by a mechanical structure from the virtual transmission to the drive wheel. A value obtained by multiplying the reduction ratio by the gear ratio is the above-mentioned overall reduction ratio. The vehicle model calculates the drive wheel torque from the transmission output torque and the reduction ratio. The calculated drive wheel torque is multiplied by the reduction ratio from the output shaft of the electric motor 44 to the drive wheel to calculate the motor torque in the manual mode.

Returning to FIG. 1 again, the automatic driving force control unit 54 will be described. The automatic driving force control unit 54 is a unit that executes a plurality of types of automatic driving force controls of changing the driving force regardless of the input from the driver. The automatic driving force control is classified into a first-type automatic driving force control and a second-type automatic driving force control.

Examples of the first-type automatic driving force control include a tire spin suppression control and a lateral slip suppression control. The first-type automatic driving force control is a control related to vehicle stability. The first-type automatic driving force control can also be defined as a control related to behavior management during traveling, or can also be defined as a control of optimizing an operation based on vehicle operation or environmental conditions. In addition, the first-type automatic driving force control can also be defined as a control with brake coordination.

Examples of the second-type automatic driving force control include DMD control, climbing control, downhill control, and dynamic G control. The DMD control is a technique of improving a driving feel by estimating a driver's mind and switching vehicle control to bring the vehicle behavior close to the vehicle behavior requested by the driver. From empirical rules, a trajectory of a friction circle calculated from vehicle front-rear acceleration and vehicle left-right acceleration has a feature that an operation along the friction circle can be performed in a situation where the driving feel is good and a friction circle radius increases as sporty driving is more pronounced. In the DMD control in the battery electric vehicle 10, a deceleration rate with respect to an accelerator OFF in a D range is controlled based on the driver's mind. The slope climbing control is a technique of realizing stable vehicle behavior by reducing an accelerator operation amount of a driver by correcting a driver-requested driving force in accordance with a gradient during slope climbing. The downhill control is a technique of switching a decelerating force during an accelerator OFF in a D range in accordance with a gradient during downhill. The dynamic G control is a technique of reading an acceleration intention of a driver from an accelerator operation speed of the driver and changing a vehicle speed-acceleration characteristic to realize a seamless acceleration extension feeling with respect to a vehicle speed increase. As exemplified above, the second-type automatic driving force control is not a control related to vehicle stability, but is a control for improving the quality of driving of the driver. In a case where the first-type automatic driving force control is basic control, the second-type automatic driving force control can be defined as added-value control.

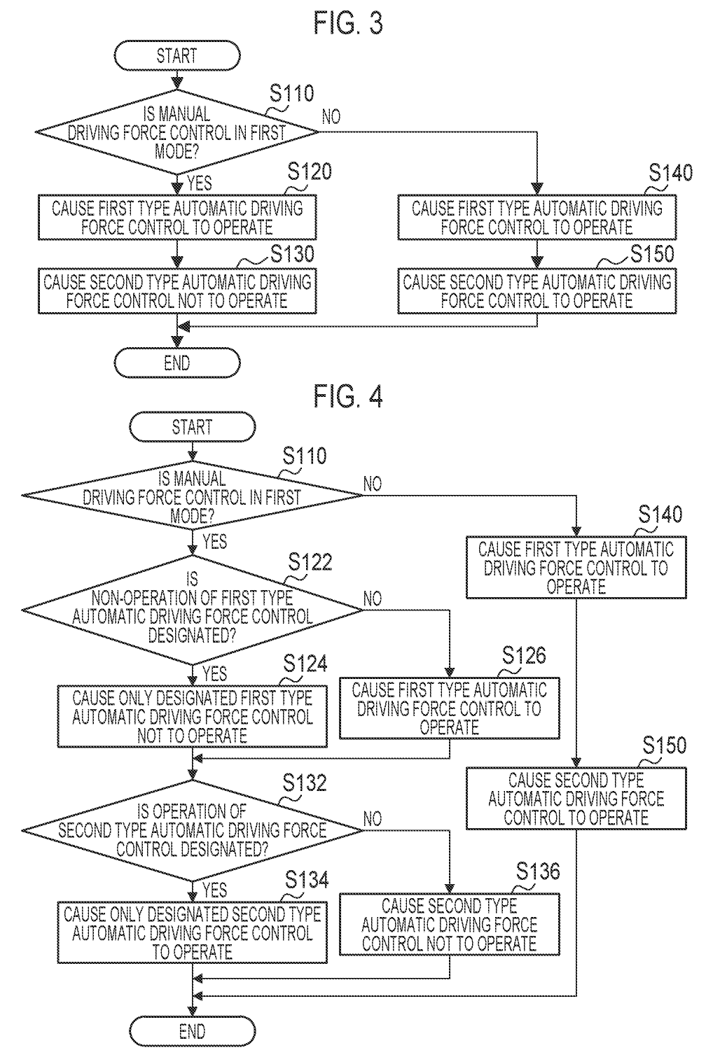

The automatic driving force control automatically operates during execution of the manual driving force control. Note that there is a difference in the determination of the operation and non-operation between the first-type automatic driving force control and the second-type automatic driving force control. FIG. 3 is a flowchart showing a first example of the determination of the operation and non-operation of the automatic driving force control. The determination shown in this flow is performed by the control device 50, specifically, by the automatic driving force control unit 54.

In S110, the control device 50 determines whether the manual driving force control currently being executed is the first mode. In a case where the manual driving force control is the first mode, the control device 50 executes S120 and S130. In S120, the control device 50 operates the first-type automatic driving force control. In S130, the control device 50 sets the second-type automatic driving force control to a non-operation state. That is, in the first mode, the first-type automatic driving force control is operated, but the second-type automatic driving force control is not operated.

On the other hand, in a case where the manual driving force control is the second mode, the control device 50 executes S140 and S150. In S140, the control device 50 operates the first-type automatic driving force control. In S150, the control device 50 also operates the second-type automatic driving force control. That is, in the second mode, both the first-type automatic driving force control and the second-type automatic driving force control are operated.

As described above, by determining the operation and non-operation of the automatic driving force control, it is possible to improve the drivability in a case where the driver drives the battery electric vehicle 10 by operating the paddle shifter 24. More specifically, in a situation where the driver desires aggressive driving by operating the paddle shifter 24, only the first-type automatic driving force control that is basic control affecting vehicle stability is operated, so that a degree of freedom of vehicle control by the driver itself can be enhanced. On the other hand, there is a situation in which the driver desires smooth driving unique to the battery electric vehicle. In this case, not only the first-type automatic driving force control but also the second-type automatic driving force control is operated, so that the quality of the vehicle control performed automatically by the battery electric vehicle 10 can be improved.

FIG. 4 is a flowchart showing a second example of the determination of the operation and non-operation of the automatic driving force control. In this flowchart, the same processing as that of the first example is denoted by the same number.

The second example is different from the first example in the processing in a case where the manual driving force control is the first mode. In a case where the manual driving force control is the first mode, in S122, the control device 50 determines whether the driver designates the non-operation of the first-type automatic driving force control. As described in the first example, the first-type automatic driving force control is a control that is operated regardless of whether the control mode is the first mode or the second mode. However, in a case where the driver wants to control the vehicle more freely, the first-type automatic driving force control may be interfering. Therefore, in the second example, the driver is given a selection as to the operation and non-operation of the first-type automatic driving force control in the first mode.

In a case where the driver designates the non-operation of some or all of the first-type automatic driving force controls in S122, the control device 50 executes S124. In S124, the control device 50 sets only the designated automatic driving force control to a non-operation state among the first-type automatic driving force controls. For example, in a case where the driver designates the lateral slip suppression control, the control device 50 sets the lateral slip suppression control to a non-operation state in the first mode.

On the other hand, in a case where the driver does not designate the non-operation of the first-type automatic driving force control in S122, the control device 50 executes S126. In S126, the control device 50 operates all the first-type automatic driving force controls.

Next, in S132, the control device 50 determines whether the driver designates the operation of the second-type automatic driving force control. As described in the first example, the second-type automatic driving force control is a control that is operated in the second mode but is not operated in the first mode. However, there is a driver who wants to control the vehicle more easily, and there is also a case where the same driver wants to control the vehicle more easily depending on the situation or the mood. Therefore, in the second example, the driver is given a selection as to the operation and non-operation of the second-type automatic driving force control in the first mode.

In a case where the driver designates the operation of some or all of the second-type automatic driving force controls in S132, the control device 50 executes S134. In S134, the control device 50 operates only the designated automatic driving force control among the second-type automatic driving force controls. For example, in a case where the slope climbing control is designated, the control device 50 operates the slope climbing control in the first mode.

On the other hand, in a case where the driver does not designate the operation of the second-type automatic driving force control in S132, the control device 50 executes S136. In S136, the control device 50 sets all the second-type automatic driving force controls to non-operation states.

As described above, by determining the operation and non-operation of the automatic driving force control, it is possible to further improve the drivability in a case where the driver drives the battery electric vehicle 10 by operating the paddle shifter 24.

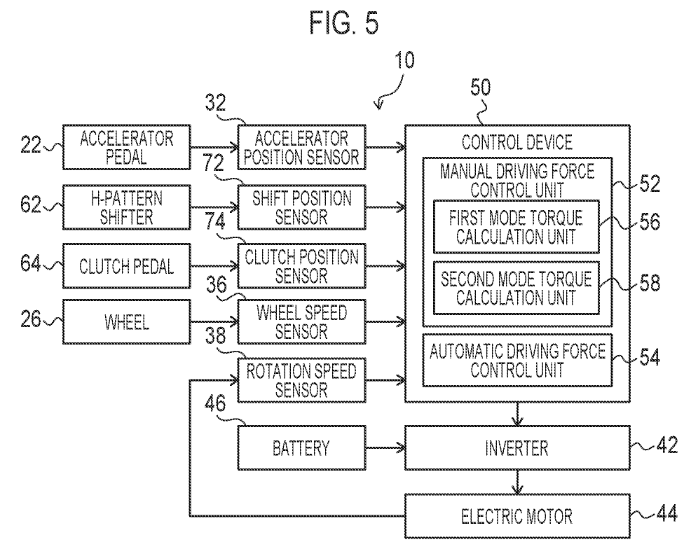

Finally, a modification of the configuration of the power control system of the battery electric vehicle 10 will be described with reference to FIG. 5. In this modification, an H-pattern shifter 62 is provided instead of the paddle shifter 24. The H-pattern shifter 62 includes a shift position sensor 72 that detects which shift gate a shift lever is in, that is, which shift position is selected. The shift position sensor 72 generates a signal indicating the selected shift position.

In addition, in this modification, a clutch pedal 64 is provided. The clutch pedal 64 includes a clutch position sensor 74 for detecting a clutch operation amount which is an operation amount of the clutch pedal 64. In this modification, the clutch operation amount detected by the clutch position sensor 74 is used for calculating the torque transmission gain using the clutch model 562. That is, in the first mode of this modification, the output characteristic of the electric motor 44 is switched by the operation of the H-pattern shifter 62 and the operation of the clutch pedal 64. On the other hand, in the second mode, the operation of the H-pattern shifter 62 by the driver or the operation of the clutch pedal 64 by the driver is not reflected in the motor torque.

What is claimed is:

1. A battery electric vehicle that travels with a driving force generated by an electric motor, the battery electric vehicle comprising:
a shifter operable by a driver; and
a control device configured to be able to execute multiple types of automatic driving force control of changing the driving force regardless of input from the driver during execution of manual driving force control of changing the driving force in response to the input from the driver, wherein:
the manual driving force control includes
a first mode in which the input from the driver includes an operation of the shifter, and an output characteristic of the electric motor is switchable in multiple stages by the operation of the shifter, and
a second mode in which the input from the driver does not include the operation of the shifter; and
the multiple types of automatic driving force control include
first-type automatic driving force control that is operated during driving in the first mode and is also operated during driving in the second mode, and
second-type automatic driving force control that is not operated during the driving in the first mode and is operated during the driving in the second mode.

2. The battery electric vehicle according to claim 1, wherein the first-type automatic driving force control includes automatic driving force control that is not operated during the driving in the first mode when the driver selects non-operation of the first-type automatic driving force control.

3. The battery electric vehicle according to claim 1, wherein the second-type automatic driving force control includes automatic driving force control that is operated during the driving in the first mode when the driver selects operation of the second-type automatic driving force control.

4. The battery electric vehicle according to claim 1, further comprising a clutch pedal operable by the driver, wherein:
in the first mode, the input from the driver includes an operation of the clutch pedal, and the output characteristic of the electric motor is switchable in multiple stages by the operation of the shifter and an operation of the clutch pedal; and
in the second mode, the input from the driver does not include the operation of the clutch pedal.

5. A non-transitory storage medium storing a program for a battery electric vehicle including a shifter operable by a driver, the program being configured to cause an in-vehicle computer to execute multiple types of automatic driving force control of changing a driving force regardless of input from the driver during execution of manual driving force control of changing the driving force in response to the input from the driver, wherein:
the manual driving force control includes
a first mode in which the input from the driver includes an operation of the shifter, and an output characteristic of an electric motor is switchable in multiple stages by the operation of the shifter, and
a second mode in which the input from the driver does not include the operation of the shifter; and
the multiple types of automatic driving force control include
first-type automatic driving force control that is operated during driving in the first mode and is also operated during driving in the second mode, and
second-type automatic driving force control that is not operated during the driving in the first mode and is operated during the driving in the second mode.
